(19) United States
(12) Patent Application Publication
(10) Pub. No.: US 2026/0033519 A1
(43) Pub. Date: Feb. 5, 2026

(54) STORAGE-STABLE BEVERAGES COMPRISING ANTHOCYANINS

(71) Applicant: Board of Trustees of Southern Illinois University, Springfield, IL (US)

(72) Inventor: Richard Richard Selinfreund, Springfield, IL (US)

(21) Appl. No.: 19/266,425

(22) Filed: Jul. 11, 2025

Related U.S. Application Data
(60) Provisional application No. 63/676,882, filed on Jul. 29, 2024.

(51) Int. Cl. A23L 2/68; A23B 70/10; A23L 2/56; A23L 2/58; A23L 2/60

(52) U.S. Cl. CPC A23L 2/68; A23B 70/10; A23L 2/56; A23L 2/58; A23L 2/60

(57) ABSTRACT

Provided herein is a preformulated, storage-stable beverage composition comprising one or more of the following components: (1) an aqueous carrier, (2) an anthocyanin component comprising one or more anthocyanins, (3) an antioxidant component comprising one or more antioxidants, and (4) one or more beverage additives. The storage-stable beverage composition preferably has a pH of less than about 3.8, and most preferably less than 3.0.

### FIELD

The present disclosure is generally directed to preformulated, storage-stable beverage compositions comprising anthocyanins.

### BACKGROUND

Anthocyanins are a class of water-soluble flavonoids widely present in fruits and vegetables such as grapes, apples, plums, cabbage, berries, and other foods containing high levels of colorants. Anthocyanins are the glycosylated form of anthocyanidins.

Preparing shelf-stable beverages that contain anthocyanins is challenging. Anthocyanins are natural pigments found in many fruits and vegetables, and they are known for their vibrant colors and potential health benefits. However, they are also sensitive to various environmental factors, which can lead to degradation over time. For example, anthocyanins are highly susceptible to oxidative degradation. The susceptibility of anthocyanins to both chemical degradation limits their commercial viability as antioxidants and coloring agents in preformulated, shelf-stable beverages.

Anthocyanins are sensitive to light, particularly UV radiation. Exposure to sunlight can cause the degradation of these pigments, leading to a loss of color and potential reduction in nutritional benefits.

Anthocyanins are also sensitive to heat. High temperatures can accelerate their degradation, which is a significant concern during the pasteurization process commonly used in beverage production to ensure microbial safety. Developing a method of formulating anthocyanin-containing beverages that can survive heat treatment to ensure is a critical challenge facing the beverage industry.

It is therefore desirable to develop a preformulated, shelf-stable beverage formulation comprising one or more anthocyanins that is physically and chemically stable and does not require the use of reagents, excipients, or other ingredients that are hazardous to human health.

More generally, it would be highly desirable to develop stable beverage formulations that maintain the high antioxidant potential of natural compounds, such as anthocyanins and ascorbic acid, that are otherwise subject to degradation and loss of antioxidant potential.

### SUMMARY

Provided herein is a storage-stable beverage composition comprising one or more anthocyanins, the composition comprising: (1) an aqueous carrier, (2) an anthocyanin component comprising one or more anthocyanins, and (3) an antioxidant component comprising one or more antioxidants, wherein the beverage composition has a pH of less than about 3.8.

Other objects and features will be in part apparent and in part pointed out hereinafter.

### DESCRIPTION OF THE DRAWINGS

The patent or application file contains at least one drawing executed in color.

Copies of this patent or patent application publication with color drawing(s) will be provided by the Office upon request and payment of the necessary fee.

FIG. 1 is a photograph of a beverage comprising anthocyanins derived from blue pea flower, which was prepared as described in Example 1.

FIG. 2 is a photograph of the composition depicted in FIG. 1 following the addition of lemon juice as described in Example 1.

FIG. 3 is a photograph of a beverage comprising anthocyanins derived from blue pea flower, which was prepared as described in Example 2.

FIG. 4 is a photograph of the composition depicted in FIG. 3 following the addition of lime juice as described in Example 2.

FIG. 5 is a photograph of a beverage comprising anthocyanins which was prepared as described in Example 4.

FIG. 6 is a photograph of the composition depicted in FIG. 5 after being stored in a location with exposure to direct sunlight for a period of greater than 6 years, as described in Example 4.

### DETAILED DESCRIPTION

Provided herein is a preformulated, storage-stable beverage composition comprising one or more of the following components: (1) an aqueous carrier, (2) an anthocyanin component comprising one or more anthocyanins, (3) an antioxidant component comprising one or more antioxidants, and (4) one or more beverage additives.

The compositions provided herein may provide one or more of the following benefits and advantages, as compared to compositions known in the prior art. For example, the compositions provided herein may serve to stabilize the anthocyanin component, the antioxidant component, or both against physical and/or chemical degradation, resulting in a beverage composition with high antioxidant potential that is suitable for long-term storage.

### Aqueous Carrier:

The beverage composition may comprise an aqueous carrier. For example, the beverage composition may comprise water.

The aqueous carrier may be carbonated or non-carbonated. Non-limiting examples of carbonated aqueous carriers include carbonated water, club soda, and tonic water.

Non-limiting examples of non-carbonated aqueous carriers include mineral water, fruit juice (e.g., citrus juice such as lemon juice or lime juice), vegetable juice, and alcoholic mixes.

### Anthocyanin Component

The beverage composition may comprise an anthocyanin component comprising one or more anthocyanins.

For example, the anthocyanin component may comprise one or more anthocyanin compounds having the following structure:

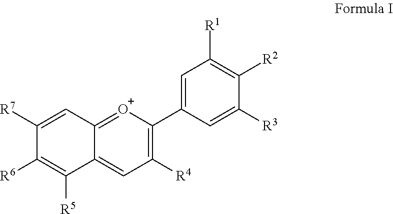

wherein R¹, R², R³, R⁴, R⁵, R⁶, and R⁷ are each independently selected from the group consisting of H, OH, and OCH₃. In preferred embodiments, R¹ is selected from the group consisting of H, OH, and OCH₃; R² is OH; R³ is selected from the group consisting of H, OH, and OCH₃; R⁴ is OH; R⁵ is selected from the group consisting of OH and OCH₃; R⁶ is selected from the group consisting of H and OH; and R⁷ is selected from the group consisting of OH and OCH₃.

The anthocyanin component may comprise one or more naturally derived anthocyanins (for example, anthocyanins extracted from a plant source), one or more synthetic anthocyanins, or a combination thereof. For example, the anthocyanin component may comprise an anthocyanin extracted from a fruit, a vegetable, or a flower.

Non-limiting examples of anthocyanins that may be present in the anthocyanin component include aurantinidin, cyanidin, delphinidin, europinidin, pelargonidin, malvidin, peonidin, petunidin, pelargonidin, and rosinidin. For example, the anthocyanin component may comprise one or more anthocyanins selected from the group consisting of cyanin, delphinidin, malvidin, peonidin, petunidin, and pelargonidin.

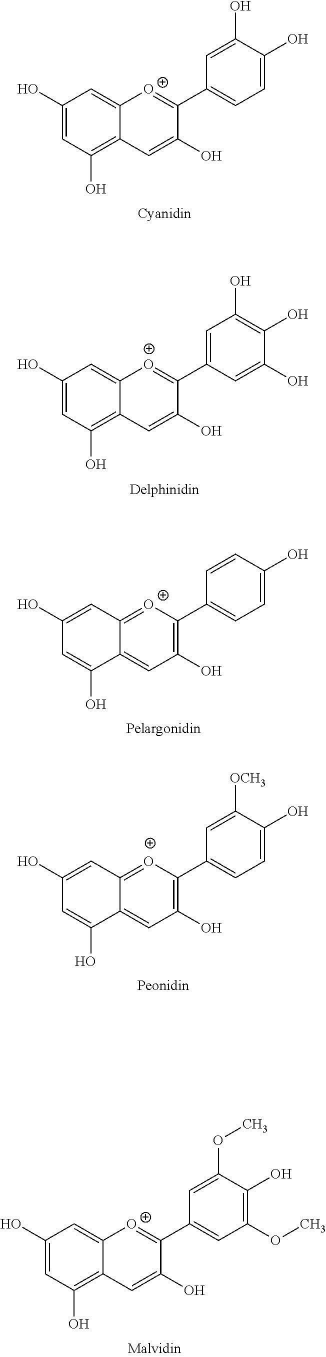 [SMILES: Oc1cc(O)c2cc(O)c(-c3ccc(O)c(O)c3)[o+]c2c1 ; Oc1cc(O)c2cc(O)c(-c3cc(O)c(O)c(O)c3)[o+]c2c1 ; Oc1ccc(-c2[o+]c3cc(O)cc(O)c3cc2O)cc1 ; COc1cc(-c2[o+]c3cc(O)cc(O)c3cc2O)ccc1O ; COc1cc(-c2[o+]c3cc(O)cc(O)c3cc2O)cc(OC)c1O]

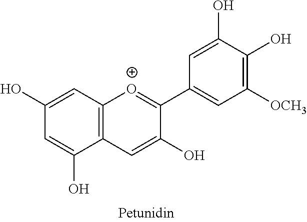 [SMILES: COc1cc(-c2[o+]c3cc(O)cc(O)c3cc2O)cc(O)c1O]

The anthocyanin component may comprise cyanidin. Cyanidin provides a magenta pigment and may be extracted, for example, from red-colored fruits and vegetables such as berries, red sweet potato, and purple corn.

The anthocyanin component may comprise delphinidin. Delphinidin provides a purple pigment and may be extracted, for example, from blue pea flowers.

The anthocyanin component may comprise malvidin. Malvidin provides a red or purple pigment and is abundantly found, for example, in blue-colored flowers.

The anthocyanin component may comprise peonidin. Peonidin provides a magenta pigment and can be found, for example, in grapes and berries.

The anthocyanin component may comprise petunidin. Petunidin provides a dark red or purple pigment and can be extracted, for example, from blackcurrants.

The anthocyanin component may comprise pelargonidin. Pelargonidin provides an orange-red pigment and may be extracted, for example, from several orange-colored flowers and red fruits and berries.

### Antioxidant Component

The beverage composition may comprise, for example, an antioxidant component comprising one or more antioxidants. The antioxidant component serves to stabilize the anthocyanin component against degradation, resulting in a beverage composition with high antioxidant potential that is suitable for long-term storage.

Non-limiting examples of suitable antioxidants include Vitamin C (ascorbic acid), Vitamin E (tocopherols and tocotrienols), Vitamin A (retinol, retinal, and carotenoids such as beta-carotene), lycopene, lutein, polyphenols, cetechins (for example, from red wine), crypto xanthine (red capsicum), phenolic acid (for example, from oilseeds), extracts of green tea, and. For example, the antioxidant component may comprise one or more antioxidants selected from the group consisting of ascorbic acid, tocopherols, tocotrienols, beta-carotene, butylated hydroxy toluene, butylated hydroxy anisole, propyl gallate, tertiary butylhydroquinone, sorbic acid, sodium sorbate, sodium benzoate, potassium benzoate, and benzoic acid.

The antioxidant component may comprise ascorbic acid. It has been discovered that when anthocyanins are combined with ascorbic acid in an aqueous carrier, the combination is particularly effective at stabilizing the anthocyanins against degradation.

The antioxidant component is typically present in a molar ratio of from about 1:1 to about 10:1 relative to the anthocyanin component. For example, the molar ratio of the antioxidant component to the anthocyanin component may be at least about 0.01:1, at least about 0.1:1, or at least about 1:1. Typically, the molar ratio of the antioxidant component to the anthocyanin component is not greater than about 300:1, not greater than about 100:1, not greater than about 50:1, not greater than about 30:1, not greater than about 20:1, not greater than about 10:1, or not greater than about 5:1. The molar ratio of the antioxidant component to the anthocyanin component may fall within a range bounded by any minimum value and any maximum value as described above. As a non-limiting example, the molar ratio of the antioxidant component to the anthocyanin component may fall within a range of from about 0.01:1 to about 300:1.

In some embodiments, the antioxidant component may predominately comprise ascorbic acid. In such embodiments, ascorbic acid is typically present in a molar ratio of from about 1:1 to about 10:1 relative to the anthocyanin component. For example, the molar ratio of ascorbic acid to the anthocyanin component may be at least about 0.01:1, at least about 0.1:1, or at least about 1:1. Typically, the molar ratio of ascorbic acid to the anthocyanin component not greater than about 300:1, not greater than about 100:1, not greater than about 50:1, not greater than about 30:1, not greater than about 20:1, not greater than about 10:1, or not greater than about 5:1. The molar ratio of ascorbic acid to the anthocyanin component may fall within a range bounded by any minimum value and any maximum value as described above. As a non-limiting example, the molar ratio of ascorbic acid to the anthocyanin component may fall within a range of from about 0.1:1 to about 20:1.

### pH and Stability of the Beverage Composition

The beverage composition preferably has a pH of less than about 3.8. For example, the beverage composition may have a pH of less than about 3.4. Most preferably, the beverage composition has a pH of less than about 3.0.

When the antioxidant component comprises one or more acidic antioxidants, the antioxidants may be added to the beverage composition in an amount sufficient to lower the pH of the beverage composition to a value within the desired range. For example, when the antioxidant component comprises ascorbic acid, the ascorbic acid may be added to the beverage composition in an amount sufficient to lower the pH of the beverage composition to a value of less than about 3.8, less than about 3.4, or less than about 3.0.

It has been discovered that lowering the pH of the beverage composition to a value of less than about 3.8, and in particular to a value of less than about 3.0, will greatly increase the storage stability of the anthocyanin component. In particular, it has been discovered that the combination of a low pH environment and an appropriate antioxidant (e.g., ascorbic acid) will significantly increase the photo-stability of anthocyanins exposed to UV radiation (e.g., sunlight). Without being bound to a particular theory, it is believed that in a low pH environment, anthocyanin compounds are less susceptible to degradation. The purple-colored flavylium ion form of anthocyanin compounds has a lower pH and is more stable than the blue colored quinoidal base form. Therefore, the lower pH, indicated by the purple color of the beverage, is believed to result in the observed improvement in storage stability for the anthocyanin compounds.

In preferred embodiments, the beverage composition maintains chemical stability (i.e., avoids significant degradation of the anthocyanin component) at temperatures of at least about 30° C. or higher. In the claimed compositions, chemical instability of the anthocyanin component would be indicated by either a loss of color or a color change (e.g., from purple to blue); the lack of a color change is therefore indicative of chemical stability. For example, a color change from blue to purple indicates that the anthocyanin component is in the more stable form (flavylium ion) and has a greater antioxidant potential. This represents a significant advantage over prior art formulations, which must be stored under cool conditions to maintain the chemical stability of the anthocyanin component. For example, the beverage composition may maintain chemical stability at a temperature of at least about 40° C., at least about 50° C., at least about 60° C., at least about 70° C., at least about 80° C., at least about 90° C., or at least about 100° C. The beverage composition may have a cloud point, for example, of at least about 40° C., at least about 50° C., at least about 60° C., at least about 70° C., at least about 80° C., or at least about 90° C. for a period of at least about 15 minutes, at least about 30 minutes, at least about 1 hour, at least about 6 hours, at least about 1 day, at least about 1 week, at least about 1 month, or at least about 6 months.

Preferably, the beverage composition maintains chemical stability for a period of at least about 1 day, at least about 1 week, at least about 2 weeks, at least about 3 weeks, or at least about 4 weeks when stored at a temperature of at least about 25° C., at least about 30° C., at least about 40° C., or at least about 50° C. For example, the beverage composition may maintain chemical stability for a period of at least about 4 weeks when stored at a temperature of at least about 50° C.

Conversely, in preferred embodiments the beverage composition will maintain chemical stability upon storage at temperatures between 0° C. and about 15° C. (i.e., conventional refrigeration temperatures). For example, the beverage composition may maintain chemical stability at a temperature of less than about 15° C., less than about 10° C., or less than about 5° C. for a period of at least about 15 minutes, at least about 30 minutes, at least about 1 hour, at least about 6 hours, at least about 1 day, at least about 1 week, at least about 1 month, or at least about 6 months.

Likewise, in preferred embodiments the beverage composition will maintain chemical stability upon exposure to sunlight for a period of at least about 1 month, at least about 3 months, at least about 6 months, or at least about 1 year. Most preferably, the beverage composition will exhibit no visible color change upon exposure to sunlight for a period of at least about 6 months.

In preferred embodiments, the beverage composition maintains physical stability (i.e., avoids phase separation or cloudiness) at temperatures of at least about 30° C. or higher. This represents a significant advantage over prior art formulations, which must be stored under cool conditions to maintain the physical stability of the anthocyanin component. For example, the beverage composition may maintain physical stability at a temperature of at least about 40° C., at least about 50° C., at least about 60° C., at least about 70° C., at least about 80° C., at least about 90° C., or at least about 100° C. The beverage composition preferably maintains physical stability, for example, of at least about 40° C., at least about 50° C., at least about 60° C., at least about 70° C., at least about 80° C., or at least about 90° C. for a period of at least about 15 minutes, at least about 30 minutes, at least about 1 hour, at least about 6 hours, at least about 1 day, at least about 1 week, at least about 1 month, or at least about 6 months when exposed to a temperature of at least about 30° C. or higher.

Preferably, the beverage composition maintains physical stability for a period of at least about 1 day, at least about 1 week, at least about 2 weeks, at least about 3 weeks, or at least about 4 weeks when stored at a temperature of at least about 25° C., at least about 30° C., at least about 40° C., or at least about 50° C. For example, the beverage composition may maintain physical stability for a period of at least about 4 weeks when stored at a temperature of at least about 50° C.

Conversely, in preferred embodiments the beverage composition will maintain physical stability upon storage at temperatures between 0° C. and about 15° C. (i.e., conventional refrigeration temperatures). For example, the beverage composition may maintain physical stability at a temperature of less than about 15° C., less than about 10° C., or less than about 5° C. for a period of at least about 15 minutes, at least about 30 minutes, at least about 1 hour, at least about 6 hours, at least about 1 day, at least about 1 week, at least about 1 month, or at least about 6 months.

### Antioxidant Capacity of the Beverage Composition

The beverage composition preferably has, and maintains, a high antioxidant capacity even after long-term storage in warm conditions and/or exposure to sunlight.

For example, the beverage composition preferably has an antioxidant capacity, expressed as vitamin C equivalent antioxidant capacity (VCEAC), of at least about 50 mg/100 g, at least about 100 mg/100 g, at least about 150 mg/100 g, at least about 200 mg/100 g, at least about 250 mg/100 g, at least about 300 mg/100 g, at least about 350 mg/100 g, or at least about 400 mg/100 g or greater.

Preferably, the beverage composition will maintain one or more VCEAC values listed above upon exposure to sunlight for a period of at least about 1 month, at least about 3 months, at least about 6 months, or at least about 1 year.

Preferably, the beverage composition will maintain one or more VCEAC values listed above for a period of at least about 1 day, at least about 1 week, at least about 2 weeks, at least about 3 weeks, or at least about 4 weeks when stored at a temperature of at least about 25° C., at least about 30° C., at least about 40° C., or at least about 50° C. For example, the beverage composition may maintain one or more VCEAC values listed above for a period of at least about 6 months when stored at a temperature of at least about 30° C.

### Beverage Additives

The beverage composition may comprise, for example, one or more beverage additives commonly used to improve the taste and/or stability of beverages. Non-limiting examples of suitable beverage additives include flavorings, sweeteners, and preservatives.

For example, the beverage composition may comprise one or more flavorings. Non-limiting examples of suitable flavorings include natural and synthetic sources of vanillin, hexyl acetate, ethyl vanillin, ethyl methylphenylglycidate, manzanate, diacetyl, acetylpropionate, acetoin, isoamyl acetate, benzaldehyde, cinnamaldehyde, ethyl propionate, methyl anthranilate, limonene, myrcene, pinenes, plant terpenes, ethyl decadienoate, allyl hexanoate, ethyl maltol, 2,4-dithiapentane, ethylvanillin, peppermint oil, methyl salicylate, glutamic acid salts, glycine salts, guanylic acid salts, inosinic acid salts, 5′-ribonucleotide salts, acetic acid, ascorbic acid, citric acid, fumaric acid, lactic acid, malic acid, phosphoric acid, tartaric acid, allyl hexanoate, benzyl acetate, bornyl acetate, butyl acetate, butyl butyrate, butyl propanoate, ethyl acetate, ethyl benzoate, ethyl butyrate, ethyl hexanoate, ethyl cinnamate, ethyl ethanoate, ethyl formate, ethyl heptanoate, ethyl isovalerate, ethyl lactate, ethyl nonanoate, ethyl pentanoate, geranyl acetate, geranyl butyrate, geranyl pentanoate, isobutyl acetate, isobutyl formate, isoamyl acetate, isopropyl acetate, linalyl acetate, linalyl butyrate, linalyl formate, methyl acetate, methyl anthranilate, methyl benzoate, methyl butyrate, methyl cinnamate, methyl pentanoate, methyl phenylacetate, nonyl caprylate, octyl acetate, octyl butyrate, pentyl acetate, amyl butyrate, pamyl caproate, amyl valerate, propyl acetate, propyl hexanoate, propyl isobutyrate, and terpenyl butyrate.

The beverage composition may comprise one or more sweeteners. Non-limiting examples of suitable sweeteners include aspartame, saccharin, cyclamate, sucralose, monk fruit extract, stevia, corn syrup, honey, table sugar, dextrose, fructose, maple syrup, neotame, acesulfame potassium, sorbitol, xylitol, lactitol, maltitol, allulose, and erythritol.

The beverage composition may comprise the one or more beverage additives in a total amount of, for example, at least about 0.1% by weight, at least about 0.5% by weight, at least about 1% by weight, at least about 2% by weight, or at least about 5% by weight.

Optionally, the beverage composition may comprise the one or more beverage additives in a total amount of no greater than about 50% by weight, no greater than about 40% by weight, no greater than about 30% by weight, no greater than about 25% by weight, no greater than about 20% by weight, no greater than about 15% by weight, no greater than about 10% by weight, no greater than about 5% by weight, no greater than about 2% by weight, or no greater than about 1% by weight. The beverage composition may comprise the one or more beverage additives in an amount that falls within a range defined by any minimum value and any maximum value provided herein. As a non-limiting example, the beverage composition may comprise the one or more beverage additives in a total amount of from about 0.1% by weight to about 10% by weight.

The following examples illustrate various aspects of the present invention. The examples should, of course, be understood to be merely illustrative of only certain embodiments of the invention and not to constitute limitations upon the scope of the invention which is defined by the claims that are appended at the end of this description.

Having described the disclosure in detail, it will be apparent that modifications and variations are possible without departing from the scope of the claims.

### EXAMPLES

The following non-limiting examples are provided to further illustrate the present disclosure.

### Example 1: Preparation of Beverage Comprising Lemon Juice

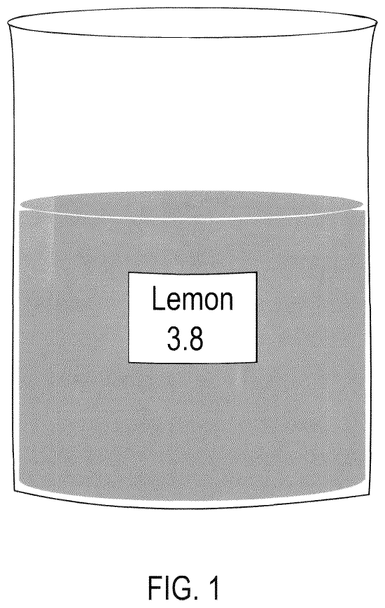

A starting beverage composition comprised of either Fever Tree or Canada Dry tonic water (355 ml) was provided having a pH of 3.80. To the starting beverage was added 0.05% by weight of SENSIENT NATURAL BLUE Catalog #04200 (available from Sensient) comprising anthocyanins derived from blue pea flower. The resulting blue-colored beverage is depicted in FIG. 1.

To the blue-colored beverage was added 11 ml of freshly squeezed lemon juice.

The addition of the lemon juice resulted in a pH of 3.4 and a color change from blue to purple.

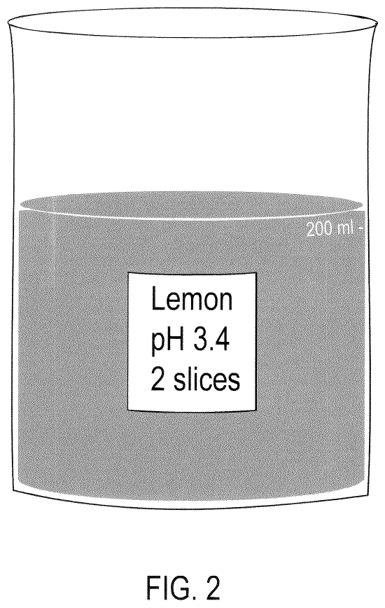

The resulting beverage is depicted in FIG. 2.

### Example 2: Preparation of Beverage Comprising Lime Juice

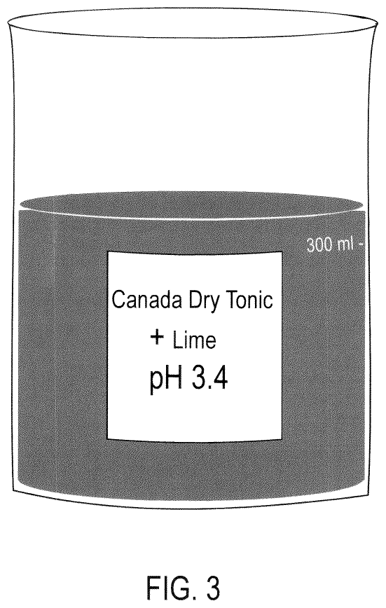

A starting beverage composition comprised of either Fever Tree or Canada Dry tonic water (355 ml) was provided having a pH of 3.80. To the starting beverage was added 0.05% by weight of SENSIENT NATURAL BLUE Catalog #04200 (available from Sensient) comprising anthocyanins derived from blue pea flower. The resulting blue-colored beverage is depicted in FIG. 3.

To the blue-colored beverage was added 12 ml of freshly squeezed lemon juice.

The addition of the lemon juice resulted in a pH of 3.4 and a color change from blue to purple.

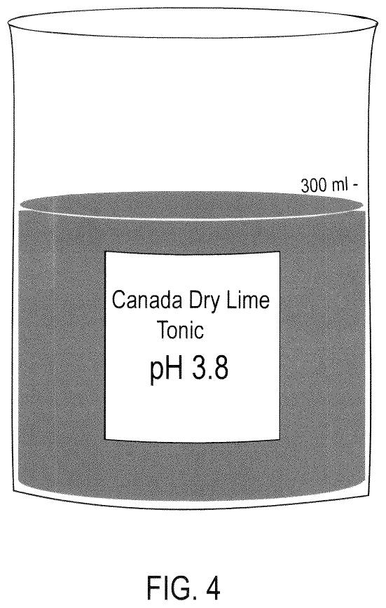

The resulting beverage is depicted in FIG. 4.

### Example 3: Preparation of Beverage Comprising Orange Juice

A starting beverage composition comprised of either Fever Tree or Canada Dry tonic water (355 ml) was provided having a pH of 3.80. To the starting beverage was added 0.05% by weight of SENSIENT NATURAL BLUE Catalog #04200 (available from Sensient) comprising anthocyanins derived from blue pea flower.

To the blue-colored beverage was added 20 ml of freshly squeezed orange juice. The addition of the orange juice did not result in a change of color or pH since the pH of freshly squeezed orange juice is approximately 3.8, the same as the starting composition.

### Example 4: Long-Term Storage Stability Testing

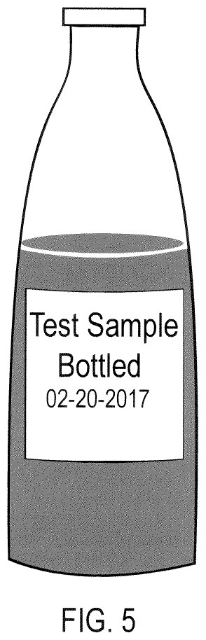

A stabilized beverage composition comprising anthocyanins was prepared using the following procedure. First, a starting beverage comprised of Canada Dry carbonated tonic water was provided. The pH of the starting beverage was adjusted to about 3.4 through addition of 1M ascorbic acid. One drop of SENSIENT NATURAL BLUE Catalog #04200 (available from Sensient) was added, resulting in a light purple color. A photograph of the stabilized beverage composition is provided as FIG. 5.

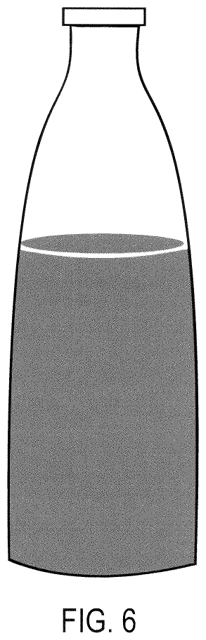

The stabilized beverage composition was then stored on a shelf with exposure to direct sunlight for a period of greater than about 6 years. As shown in FIG. 6, the stabilized beverage composition exhibited no color change during this period. The lack of color change indicates that the composition has maintained excellent chemical stability even upon exposure to direct sunlight for an extended period.

When introducing elements of the present disclosure or the preferred embodiment(s) thereof, the articles “a”, “an”, “the”, and “said” are intended to mean that there are one or more of the elements. The terms “comprising”, “including”, and “having” are intended to be inclusive and mean that there may be additional elements other than the listed elements.

In view of the above, it will be seen that the several objects of the disclosure are achieved and other advantageous results attained.

As various changes could be made in the above products and methods without departing from the scope of the disclosure, it is intended that all matter contained in the above description shall be interpreted as illustrative and not in a limiting sense.

What is claimed is:

1. A storage-stable beverage composition comprising one or more anthocyanins, the composition comprising:
(1) an aqueous carrier,
(2) an anthocyanin component comprising one or more anthocyanins, and
(3) an antioxidant component comprising one or more antioxidants,
wherein the beverage composition has a pH of less than about 3.8.

2. The storage-stable beverage composition of claim 1 wherein the beverage composition maintains chemical stability when stored in a location having exposure to direct sunlight for a period of at least about 6 months.

3. The storage-stable beverage composition of claim 1 wherein the aqueous carrier comprises a carbonated beverage selected from the group consisting of carbonated water, club soda, and tonic water.

4. The storage-stable beverage composition of claim 1 wherein the aqueous carrier comprises a non-carbonated beverage selected from the group consisting of mineral water, fruit juice (e.g., citrus juice such as lemon juice or lime juice), vegetable juice, and alcoholic mixes.

5. The storage-stable beverage composition of claim 1 wherein the anthocyanin component comprises one or more anthocyanin compounds having the following structure: 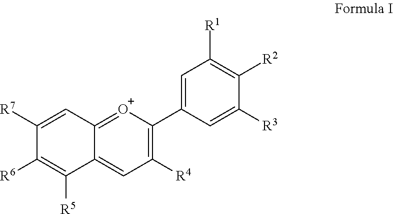
wherein R¹, R², R³, R⁴, R⁵, R⁶, and R⁷ are each independently selected from the group consisting of H, OH, and OCH₃.

6. The storage-stable beverage composition of claim 5 wherein the anthocyanin component comprises a compound of Formula I wherein
R¹ is selected from the group consisting of H, OH, and OCH₃;
R² is OH;
R³ is selected from the group consisting of H, OH, and OCH₃;
R⁴ is OH;
R⁵ is selected from the group consisting of OH and OCH₃;
R⁶ is selected from the group consisting of H and
OH; and R⁷ is selected from the group consisting of
OH and OCH₃.

7. The storage-stable beverage composition of claim 5 wherein the anthocyanin component comprises at least one compound selected from the group consisting of aurantinidin, cyanidin, delphinidin, europinidin, pelargonidin, malvidin, peonidin, petunidin, pelargonidin, rosinidin cyanin, delphinidin, malvidin, peonidin, petunidin, and pelargonidin.

8. The storage-stable beverage composition of claim 1 wherein the antioxidant component comprises one or more antioxidants selected from the group consisting of Vitamin C, Vitamin E, Vitamin A, lycopene, lutein, polyphenols, cetechins, crypto xanthine, phenolic acid, extracts of green tea, butylated hydroxyanisole (BHA), butylated hydroxytoluene (BHT), tertbutylhydroquinone (TBHQ), ethoxyquin, and propyl gallate.

9. The storage-stable beverage composition of claim 1 wherein the antioxidant component comprises one or more synthetic antioxidants selected from the group consisting of butylated hydroxyanisole (BHA), butylated hydroxytoluene (BHT), tertbutylhydroquinone (TBHQ), ethoxyquin, and propyl gallate.

10. The storage-stable beverage composition of claim 1 wherein the antioxidant component comprises one or more antioxidants selected from the group consisting of ascorbic acid, tocopherols, tocotrienols, beta-carotene, butylated hydroxy toluene, butylated hydroxy anisole, propyl gallate, tertiary butylhydroquinone, sorbic acid, sodium sorbate, sodium benzoate, potassium benzoate, and benzoic acid, ascorbic acid.

11. The storage-stable beverage composition of claim 1 comprising the antioxidant component in a molar ratio of from about 1:1 to about 10:1 relative to the anthocyanin component.

12. The storage-stable beverage composition of claim 1 wherein the composition has a pH of less than about 3.8.

13. The storage-stable beverage composition of claim 1 wherein the composition maintains chemical stability when exposed to a temperature of at least about 50° C. for a period of at least about 4 weeks.

14. The storage-stable beverage composition of claim 1 wherein the composition maintains physical stability when exposed to a temperature of at least about 50° C. for a period of at least about 4 weeks.

15. The storage-stable beverage composition of claim 1 further comprising one or more beverage additives selected from the group consisting of flavorings, sweeteners, and preservatives.

16. The storage-stable beverage composition of claim 15 comprising at least one flavoring selected from the group consisting of natural and synthetic sources of vanillin, hexyl acetate, ethyl vanillin, ethyl methylphenylglycidate, manzanate, diacetyl, acetylpropionate, acetoin, isoamyl acetate, benzaldehyde, cinnamaldehyde, ethyl propionate, methyl anthranilate, limonene, myrcene, pinenes, plant terpenes, ethyl decadienoate, allyl hexanoate, ethyl maltol, 2,4 dithiapentane, ethylvanillin, peppermint oil, methyl salicylate, glutamic acid salts, glycine salts, guanylic acid salts, inosinic acid salts, 5′-ribonucleotide salts, acetic acid, ascorbic acid, citric acid, fumaric acid, lactic acid, malic acid, phosphoric acid, tartaric acid, allyl hexanoate, benzyl acetate, bornyl acetate, butyl acetate, butyl butyrate, butyl propanoate, ethyl acetate, ethyl benzoate, ethyl butyrate, ethyl hexanoate, ethyl cinnamate, ethyl ethanoate, ethyl formate, ethyl heptanoate, ethyl isovalerate, ethyl lactate, ethyl nonanoate, ethyl pentanoate, geranyl acetate, geranyl butyrate, geranyl pentanoate, isobutyl acetate, isobutyl formate, isoamyl acetate, isopropyl acetate, linalyl acetate, linalyl butyrate, linalyl formate, methyl acetate, methyl anthranilate, methyl benzoate, methyl butyrate, methyl cinnamate, methyl pentanoate, methyl phenylacetate, nonyl caprylate, octyl acetate, octyl butyrate, pentyl acetate, amyl butyrate, pamyl caproate, amyl valerate, propyl acetate, propyl hexanoate, propyl isobutyrate, and terpenyl butyrate.

17. The storage-stable beverage composition of claim 15 comprising at least one sweetener selected from the group consisting of aspartame, saccharin, cyclamate, sucralose, monk fruit extract, stevia, corn syrup, honey, table sugar, dextrose, fructose, maple syrup, neotame, acesulfame potassium, sorbitol, xylitol, lactitol, maltitol, allulose, and erythritol.

18. The storage-stable beverage composition of claim 15 comprising the one or more beverage additives in a total amount of from about 0.1% by weight to about 10% by weight.

19. The storage-stable beverage composition of claim 1 wherein the one or more anthocyanins maintain an increased antioxidant potential when exposed to a temperature of at least 15° C. for a period of at least 4 weeks.
